(19) United States
(12) Patent Application Publication
(10) Pub. No.: US 2020/0240182 A1
(43) Pub. Date: Jul. 30, 2020

(54) GAPLESS DOOR HANDLE ASSEMBLIES FOR VEHICLES INCLUDING TOUCH SWITCHES

(71) Applicant: Toyota Motor Engineering & Manufacturing North America, Inc., Plano, TX (US)

(72) Inventors: Tarakorn Soonthornwinate, Ann Arbor, MI (US); Yuki Kai, Saline, MI (US); Takashi Sasaki, Ann Arbor, MI (US)

(73) Assignee: Toyota Motor Engineering & Manufacturing North America, Inc., Plano, TX (US)

(21) Appl. No.: 16/262,493

(22) Filed: Jan. 30, 2019

(51) Int. Cl. E05B 85/16; E05B 83/40; B60J 5/06

(52) U.S. Cl. CPC E05B 85/16; E05B 83/40; E05Y 2900/531; B60J 5/06; E05B 81/77

(57) ABSTRACT

A vehicle includes a body and a vehicle door assembly coupled to the body. The vehicle door assembly includes a door latch assembly operable to latch and unlatch the vehicle door assembly to the body. A door lock assembly is operable to lock and unlock the door latch assembly. A door handle assembly is operatively coupled to the door latch assembly. The door handle assembly moves between a latched configuration and an unlatched configuration. An actuator actuates the door lock assembly. The door handle assembly is gapless and comprises a handle body that pivots about a pivot axis between the latched configuration and the unlatched configuration, the handle body includes a touch switch.

### TECHNICAL FIELD

The present specification generally relates to door handle assemblies for vehicles and, more specifically, to gapless door handle assemblies for vehicles that include touch switches.

### BACKGROUND

Door latch assemblies for vehicles may be provided and are used to latch a vehicle door, such as a driver side door or a passenger side door in a closed position. The door latch assemblies may include a door latch device within the vehicle door that can engage a cooperating structure, such as a striker that is located on a frame of the vehicle. The vehicle door may remain in the closed position until a vehicle occupant actuates a door handle, which then opens the door latch device.

Some door handle assemblies include the door handles with a touch switch located on the door handle. These door handle assemblies may include a stationary portion that includes a key lock mechanism and the door handle that is a moveable portion. A gap may be provided between the stationary portion and the moveable portion to allow for movement of the door handle relative to the stationary portion.

### SUMMARY

In one embodiment, a vehicle includes a body and a vehicle door assembly coupled to the body. The vehicle door assembly includes a door latch assembly operable to latch and unlatch the vehicle door assembly to the body. A door lock assembly is operable to lock and unlock the door latch assembly. A door handle assembly is operatively coupled to the door latch assembly. The door handle assembly moves between a latched configuration and an unlatched configuration. An actuator actuates the door lock assembly. The door handle assembly is gapless and comprises a handle body that pivots about a pivot axis between the latched configuration and the unlatched configuration, the handle body includes a touch switch that is used to control operation of the actuator.

In another embodiment, a vehicle door assembly includes a door latch assembly operable to latch and unlatch the vehicle door assembly to the body. A door lock assembly is operable to lock and unlock the door latch assembly. A door handle assembly is operatively coupled to the door latch assembly. The door handle assembly moves between a latched configuration and an unlatched configuration. An actuator actuates the door lock assembly. The door handle assembly is gapless and comprises a handle body that pivots about a pivot axis between the latched configuration and the unlatched configuration, the handle body includes a touch switch that is used to control operation of the actuator.

In another embodiment, a method of operating a vehicle door assembly comprising a door handle assembly is provided. The method includes instructing a door lock assembly to actuate from an unlocked configuration to a locked configuration with an actuator using a touch switch. A door latch assembly is instructed to actuate from a latched configuration to an unlatched configuration with the actuator using the touch switch. A power slide door unit is instructed to move the door assembly from a closed configuration to an open configuration using the touch switch. The door handle assembly is gapless and includes a handle body that pivots about a pivot axis between the latched configuration and the unlatched configuration, the handle body comprising the touch switch.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 depicts a side view of a vehicle, according to one or more embodiments shown and described herein;

FIG. 2 illustrates an interior, perspective view of the vehicle of FIG. 1, according to one or more embodiments shown and described herein;

FIG. 3 is a side view of a door handle of the vehicle of FIG. 1, according to one or more embodiments shown and described herein;

FIG. 4 is an exploded view of a door handle of the vehicle of FIG. 1, according to one or more embodiments shown and described herein;

FIG. 5 is a section view of the door handle of FIG. 4 in an assembled state, according to one or more embodiments shown and described herein;

FIG. 6 is an interior view of the door handle of FIG. 4 in an assembled state, according to one or more embodiments shown and described herein; and

FIG. 7 schematically illustrates a door operating system for use with the vehicle of FIG. 1, according to one or more embodiments shown and described herein.

### DETAILED DESCRIPTION

Embodiments described herein are generally related to vehicles including vehicle door assemblies that include door handle assemblies. The door handle assemblies are used to control a door lock assembly and a door latch assembly of the vehicle door assemblies. The door handle assembly includes a moveable door handle that can be moved between a latched configuration, an unlocked configuration and an unlatched configuration. The door handle assembly also includes a touch switch that can be used to control the door lock assembly and the door latch assembly in a motorized fashion without manually actuating the door handle. As will be described in greater detail herein, the door handle assembly is considered to be “gapless” in that there is no stationary portion of the door handle assembly alongside the door handle and no gap between a moveable portion of the door handle assembly and a stationary portion of the door handle assembly. The door handle has a continuous, monolithic shell that can move between the latched configuration, the unlocked configuration and the unlatched configuration.

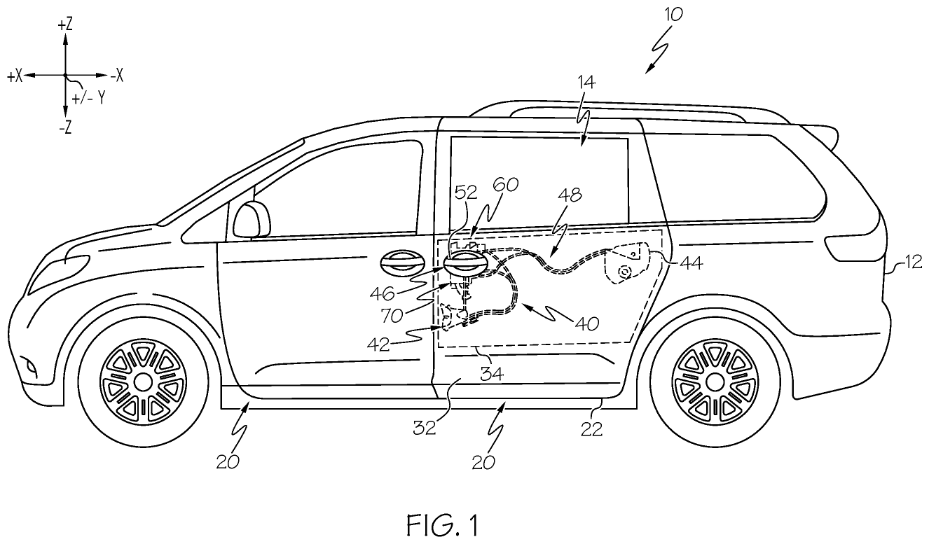

As used herein, the term “vehicle longitudinal direction” refers to the forward-rearward direction of the vehicle 10 (i.e., in the +/− vehicle X-direction depicted in FIG. 1). The term “vehicle lateral direction” refers to the cross-vehicle direction of the vehicle (i.e., in the +/− vehicle Y-direction depicted in FIG. 1), and is transverse to the vehicle longitudinal direction. The term “vehicle vertical direction” refers to the upward-downward direction of the vehicle (i.e., in the +/− vehicle Z-direction as depicted). Further, the terms “inboard” and “outboard” are used to describe the relative positioning of various components relative to a centerline of the vehicle. Because the vehicle structure of the vehicle may be generally symmetrical about the vehicle centerline, the use of terms “inboard” and “outboard” may be switched when evaluating components positioned along opposite sides of the vehicle.

Referring now to FIG. 1, a vehicle 10 according to various embodiments is illustrated. It is noted that while the vehicle 10 is depicted as a passenger van, the vehicle 10 may be any passenger vehicle 10 such as, for example, a terrestrial, aquatic, and/or airborne vehicle. The vehicle 10 includes a body 12 characterizing a frame of the vehicle 10. The body 12 of the vehicle 10 defines an interior passenger compartment 14.

The vehicle 10 includes a number of door assemblies 20 enclosing the interior of the vehicle 10. Each door assembly 20 is slidingly, pivotally, or otherwise connected to the body 12 of the vehicle 10 such that the door assembly 20 is capable of moving between a closed position and an open position. In particular, a rear passenger door assembly 22 may be slidingly connected to the body 12 of the vehicle 10. It is noted that while the remaining description will focus on latch assemblies as part of a sliding rear passenger door assembly 22, similar latch assemblies may be utilized in swinging or hingedly coupled passenger and driver doors.

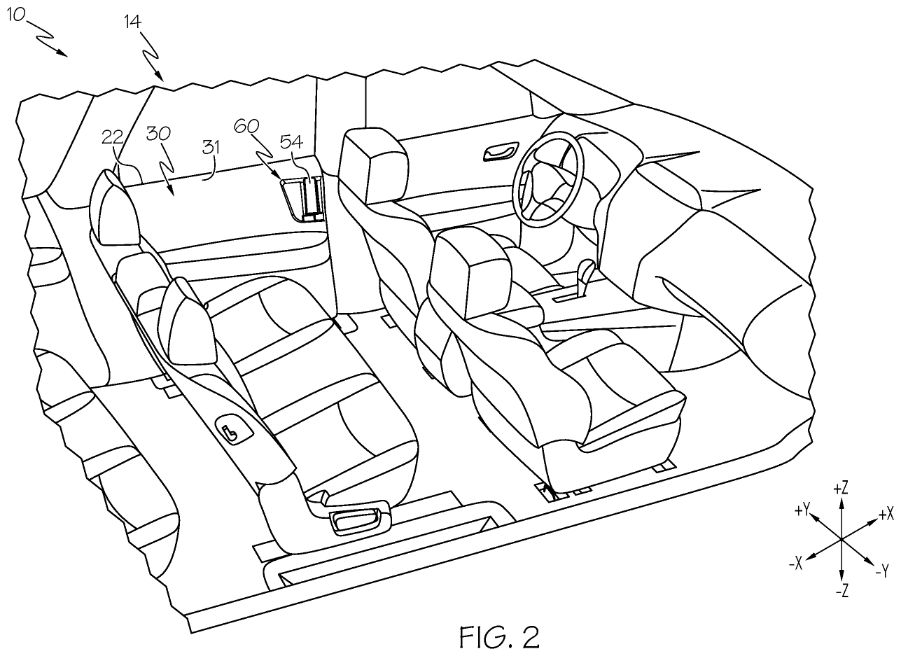

Referring collectively to FIGS. 1 and 2, the rear passenger door assembly 22 is constructed from rigidly interconnected door frame members and door panels, as well as any combination of overlying panels, trim, upholstery and other door coverings. The door panels include an upright inner door panel 30 (outboard of a trim panel 31) and an upright outer door panel 32. In some embodiments, there may be additional outer and/or inner door panels. The inner door panel 30 and the outer door panel 32 are spaced apart from one another in the vehicle lateral direction. As a result, the rear passenger door assembly 22 has an interior door cavity 34 (shown in FIG. 1) defined between the inner door panel 30 and the outer door panel 32.

The interior door cavity 34 can house various components of the rear passenger door assembly 22. In particular, the interior door cavity 34 houses a portion of the door latch assembly 40 schematically illustrated by dashed lines in FIG. 1. The door latch assembly 40 operates to latch and unlatch the rear passenger door assembly 22. The door latch assembly 40 includes one or more latching mechanisms (e.g., front latching mechanism 42, rear latching mechanism 44) operable to latch the rear passenger door assembly 22 to the body 12 of the vehicle 10, a door handle assembly 46 that is operatively coupled to the one or more latching mechanisms, and a linking system 48 which operatively couples the door handle assembly 46 to the one or more latching mechanisms such that rotation 50 of a handle (e.g., exterior door handle 52 and interior door handle 54) of the door handle assembly 46 causes the one or more latching mechanisms to unlatch the rear passenger door assembly 22.

A door lock assembly 60 may be linked to the door latch assembly 40 and the door handles 52 and/or 54. The door lock assembly 60 can be used to disengage the door handles 52 and 54 from the door latch assembly 40 in a locked configuration, to disallow unlatching of the door latch assembly 40 using the door handles 52 and 54. The door lock assembly 60 may be operated a variety of ways. For example, the door lock assembly 60 may be operated using a door lock pin that extends outwardly from the inner door panel 30. An actuator 70 (e.g., a motor) may be used to operate the door lock assembly 60 upon user command using, for example, the exterior door handle 52, as will be described in greater detail below.

Each latching mechanism may be fixedly mounted within the interior door cavity 34. In one embodiment, the door latch assembly 40 includes the front latching mechanism 42, positioned toward a front portion of the rear passenger door assembly 22 in the vehicle longitudinal direction, and the rear latching mechanism 44, positioned toward a rear portion of the rear passenger door assembly 22 in the vehicle longitudinal direction. For example, the front latching mechanism 42 may be positioned in a front lower quadrant of the rear passenger door assembly 22 and the rear latching mechanism 44 may be positioned in a rear upper quadrant of the rear passenger door assembly 22. However, it is contemplated that the front and rear latching mechanisms 42, 44 may be positioned anywhere within the rear passenger door assembly 22 that is suitable for latching the rear passenger door assembly 22 in the closed position. The front and rear latching mechanisms 42, 44 are operable to move a latch from a latched position where it is coupled to the body 12 of the vehicle 10, wherein the rear passenger door assembly 22 is unable to move relative to the body 12 of the vehicle 10, to an unlatched position, wherein the rear passenger door assembly 22 is free to move relative to the body 12 of the vehicle 10. In some embodiments, there may be latching mechanisms in addition to the front and rear latching mechanisms 42, 44.

The linking system 48 operatively couples the door handle assembly 46 to the one or more latching mechanisms so as to allow a user to unlatch the vehicle door assembly 20 by operating a door handle (e.g., exterior door handle 52 shown in FIG. 1) of the door handle assembly 46. The linking system 48 may include various rods, cables, levers, and the like to operate the one or more latching mechanisms. Accordingly, under normal operating conditions, a handle (e.g., exterior door handle 52) of the door handle assembly 46 may be actuated by a user to unlatch the one or more latching mechanisms. In some embodiments, the linking system 48 may also link the actuator 70 (e.g., a motor) to one or both of the door latch assembly 40 and the door lock assembly 60 for their motorized actuation. While one actuator is illustrated, there may be multiple actuators that actuate the door latch assembly 40 and the door lock assembly 60.

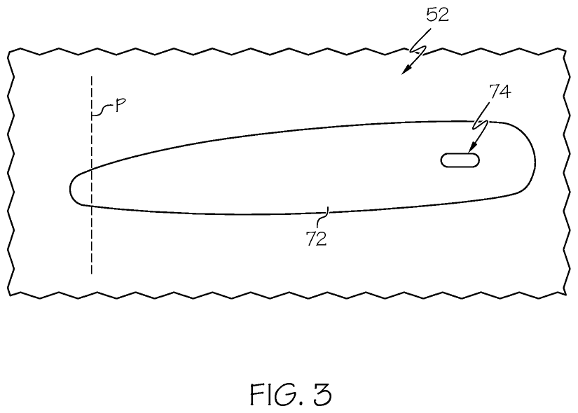

FIG. 3 illustrates the exterior door handle 52 in isolation and includes a handle body 72 that is pivotally connected to the door assembly 20 (FIG. 1) at a pivot axis P. The pivot axis P is located at an end of the handle body 72. While the pivot axis P is located at a forward end of the handle body 72, the pivot axis P may be located at a rearward end of the handle body 72. At an opposite end of the handle body 72 from the pivot axis P is a touch switch 74. The touch switch 74 can be actuated by an operator of the vehicle 10 in order to place the door lock assembly in wither the locked configuration or the unlocked configuration. In the illustrated example, the touch switch may be manually depressed in order to actuate the touch switch. Other touch sensors may be used, such as a capacitive touch sensor.

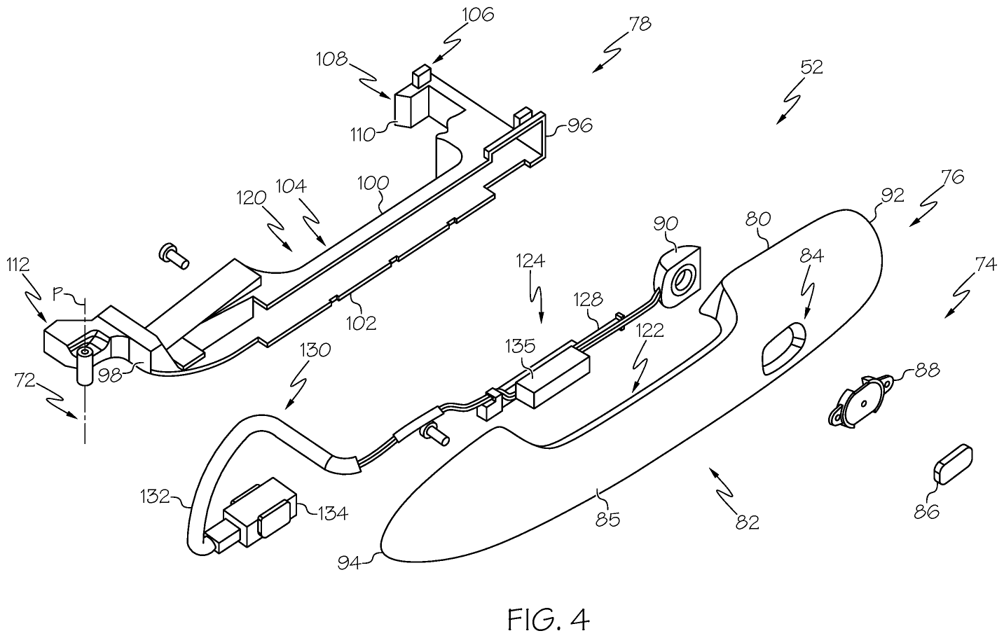

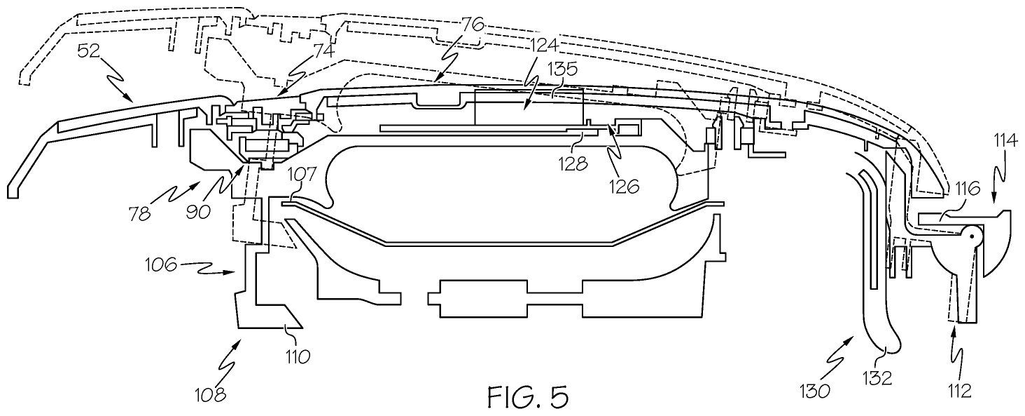

Referring to FIGS. 4 and 5, the exterior door handle 52 is illustrated in exploded and cross-section views, respectively. The handle body 72 includes an outboard portion 76 and an inboard portion 78 that connects to the outboard portion 76. The outboard portion 76 has a rounded contour between side edges 80 and 82 to a rounded apex 85 to provide an internal volume between the outboard portion 76 and the inboard portion 78 when connected together. The outboard portion 76 further includes an opening 84 that is sized to receive the touch switch 74. The touch switch 74 includes a cover 86, an intermediate component 88 and a switch assembly 90. The intermediate component 88 is used in mounting the switch assembly 90 to the outboard portion 76 at the opening 84. The intermediate component 88 can further provide an interface between the cover 86 and the switch assembly 90 that allows for manual actuation of the switch assembly 90. For example, the intermediate component 88 may have an initial position and a deflected position where the intermediate component 88 engages the switch assembly 90 to actuate the switch assembly 90. The intermediate component 88 may be biased toward the initial position. In some embodiments, the cover 86 and the intermediate component 88 may be combined into a single component.

The outboard portion 76 further has opposite ends 92 and 94. The touch switch 74 is located nearer the end 92, which is the end 92 that swings from an inboard position to an outboard position based on actuation of the exterior door handle 52. The end 94 is located nearer to the pivot location P, which is provided by the inboard portion 78. As mentioned above, the pivot location P may be located at a rearward end and the touch switch 74 may be located at the opposite end. The end 94 may also swing from an inboard position to an outboard position during actuation of the exterior door handle 52; however, a travel path of the end 94 from the inboard position to the outboard position may be less distance than a travel path of the end 92.

The inboard portion 78 has ends 96 and 98 and side edges 100 and 102 that extends between the ends 96 and 98. A base 104 extends between the ends 96, 98 and side edges 100 and 102. The base 104 is relatively planar compared to the contour of the outboard portion 76 such that the internal volume is provided between the outboard portion 76 and the inboard portion 78 when connected together. At the end 96, a catch arm 106 is provided that can be used to catch a fixed support structure 107 that is located within the door assembly 22. In particular, the catch arm 106 includes a hook 108 that includes a head 110 that extends outward in the vehicle longitudinal direction to catch the support structure 107 when the door handle 52 is pulled toward the outboard position (shown by dashed lines in FIG. 5). At the end 98, a pivot arm 112 is provided that is pivotally connected to a fixed support structure 114.

The inboard portion 78 and the outboard portion 76 may each include a recess 120 and 122, respectively, that together form an opening between the door handle 52 and the door assembly 22 that is sized to receive a hand of an operator in order to actuate or otherwise engage the door handle 52. As represented by FIG. 5, as the door handle 52 is moved into the outboard position, the pivot arm 112 can pivot while also flexing around a corner 116 of the support structure 114 thereby allowing the opposite end 96 to move outboard a greater distance than end 98.

A connector assembly 124 is located within the internal volume 126 between the outboard portion 76 and the inboard portion 78. The connector assembly 124 supports a communication line 128 (e.g., an electrical wire) that extends from the switch assembly 90 to a harness 130 for sending a signal from the touch switch 74 to a processor, e.g., of an electronic control unit (ECU) of the vehicle 10. A support member 135 in the form of a block (e.g., of foam) may be used to support the communication line 128 within the internal volume 126. The communication line 128 is received by a tail portion 132 of the harness 130 and is connected to a connector portion 134 that communicatively connects to a mating connector.

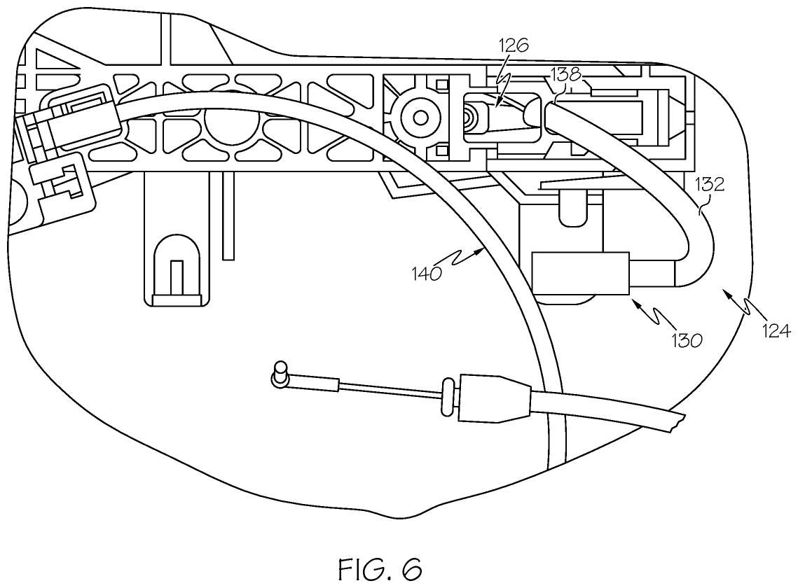

As can be seen more particularly by FIG. 5, the harness 130 has the tail portion 132 that is located near (e.g., within 4 inches, within 3 inches, within 2 inches, within 1 inch) to the pivot axis P. In the illustrated embodiment, the tail portion 132 abuts the pivot arm 112. Locating the tail portion 132 near the pivot axis P can allow the connector assembly 124 to extend from the touch switch 74 and through the internal volume 126 to the harness 130 with reduced need for slack in the communication line 128 to accommodate outboard movement of the door handle 52. As shown in FIG. 6, the connector assembly 124 exits the internal volume 126 through an opening 138 provided through the inboard portion 78. Various actuation lines (e.g., line 140) may be provided for actuating other components, such as for manually actuating the door lock assembly 60 and/or the door latch assembly 40.

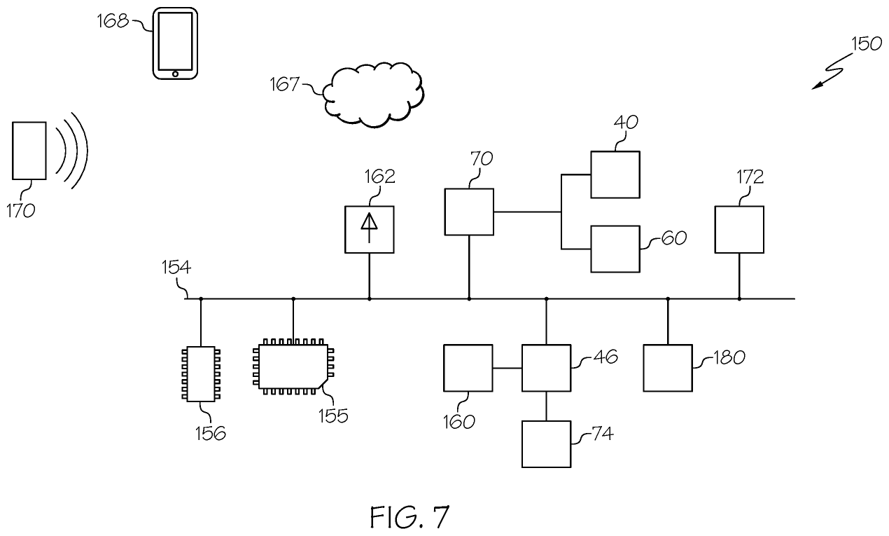

Referring now to FIG. 7, a door operating system 150 of the vehicle 10 is illustrated schematically. The door operating system 150 includes a communication path 154 including the connector assembly 124, a processor 155, a memory module 156, the door latch assembly 40, the door lock assembly 60, the door handle assembly 46 including the touch switch 74 and actuator 70.

The door operating system 150 includes the communication path 154 that provides data interconnectivity between various modules disposed within the door operating system 150. Specifically, each of the modules can operate as a node that may send and/or receive data. In some embodiments, the communication path 154 includes a conductive material that permits the transmission of electrical data signals to processors, memories, sensors, and actuators throughout the door operating system 150. In some embodiments, the communication path 154 can be a bus, such as for example a LIN bus, a CAN bus, a VAN bus, and the like. In further embodiments, the communication path 154 may be wireless and/or an optical waveguide. Components that are communicatively coupled may include components capable of exchanging data signals with one another such as, for example, electrical signals via conductive medium, electromagnetic signals via air, optical signals via optical waveguides, and the like.

The door operating system 150 includes the processor 155 communicatively coupled with the memory module 156 over the communication path 154. The processor 155 may include any device capable of executing machine-readable instructions stored on a non-transitory computer-readable medium. The processor 155 may include one or more processors. Accordingly, each processor 155 may include a controller, an integrated circuit, a microchip, a computer, and/or any other computing device.

The memory module 156 is communicatively coupled to the processor 155 over the communication path 154. The memory module 156 may be configured as volatile and/or nonvolatile memory and, as such, may include random access memory (including SRAM, DRAM, and/or other types of RAM), flash memory, secure digital (SD) memory, registers, compact discs (CD), digital versatile discs (DVD), and/or other types of non-transitory computer-readable mediums. Depending on the particular embodiment, these non-transitory computer-readable mediums may reside within the door operating system 150 and/or external to the door operating system 150. The memory module 156 may be configured to store one or more pieces of logic. The memory module 156 may include one or more memory modules. The embodiments described herein may utilize a distributed computing arrangement to perform any portion of the logic described herein.

Embodiments of the present disclosure include logic stored on the memory module 156 that includes machine-readable instructions and/or an algorithm written in any programming language of any generation (e.g., 1GL, 2GL, 3GL, 4GL, and/or 5GL) such as, machine language that may be directly executed by the processor 155, assembly language, object-oriented programming (OOP), scripting languages, microcode, etc., that may be compiled or assembled into machine readable instructions and stored on a machine readable medium. Similarly, the logic and/or algorithm may be written in a hardware description language (HDL), such as logic implemented via either a field-programmable gate array (FPGA) configuration or an application-specific integrated circuit (ASIC), and their equivalents. Accordingly, the logic may be implemented in any conventional computer programming language, as pre-programmed hardware elements, and/or as a combination of hardware and software components.

The door operating system 150 further includes the actuator 70. The actuator 70 may include one or more actuators that can be used to move the door latch assembly 40 between latched and unlatched configurations and to move the door lock assembly 60 between locked and unlocked configurations. A power slide door (PSD) unit 180 that includes a motor, pulley and cable system may also be used to move the door assembly 22 between closed and open configurations upon command without any need for operator movement of the door assembly 22. The actuator 70 can be coupled to the communication path 154 and communicatively coupled to the processor 155 to control movement and positioning of the door latch assembly 40, door lock assembly 60 and door assembly 22.

The door operating system 150 also includes the door handle assembly 46 including the touch switch 74. The touch switch 74 may provide a signal to the processor 155 that can be used to control the actuator 70. For example, the touch switch 74 may provide a signal to the processor 155 based on an operator touch of the touch switch 74. The processor 155 may then instruct the actuator 70 to place the door lock assembly 60 in either the locked configuration or the unlocked configuration based on the operator touch. In some embodiments, the touch switch 74 may also provide another signal to the processor 155 based on an operator touch of the touch switch 74. The processor 155 may then instruct the actuator 70 to place the door latch assembly 40 in either the latched configuration or the unlatched configuration based on the operator touch. Further, the touch switch 74 may be used to provide a signal to the processor 155 based on an operator touch of the touch switch 74 such that the processor 155 instructs the PSD unit 180 to move the door assembly 22 between the closed configuration and the open configuration automatically.

The door handle assembly 46 further includes the door handle 52, which may also be used to control the actuator 70 and the PSD unit 180 via the processor 155. The door handle 52 may have, for example, a latched configuration, an unlocked configuration and an unlatched configuration with the door assembly 22 in the closed configuration. A sensor 160 associated with the door handle assembly 46 may provide a signal to the processor 155 indicative of whether the door handle 52 is in the unlocked configuration and the unlatched configuration. For example, moving the door handle 52 manually to a first, intermediate position may place the door handle 52 in the unlocked configuration. In this unlocked configuration, the sensor 160 may provide a signal to the processor 155 that is indicative of the position of the door handle 52 and the processor 155 may instruct the actuator 70 to place the door lock assembly 60 in the unlocked configuration. Further, moving the door handle 52 manually to a second, more outboard position may place the door handle 52 in the unlatched configuration. In this unlatched configuration, the sensor 160 may provide a signal to the processor 155 that is indicative of the position of the door handle 52 and the processor 155 may instruct the actuator 70 to place the door latch assembly 40 in the unlatched configuration. In the unlatched configuration, the processor 155 may also instruct the PSD unit 180 to move the door assembly 22 from the closed configuration to the open configuration. With the door assembly 22 in the open configuration, the sensor 160 may provide another signal to the processor 155 with another movement of the door handle 52 toward the second position and the processor 155 may instruct the PSD unit to move the door assembly 22 from the open configuration to the closed configuration.

In another embodiment, if the door assembly 22 is in the closed configuration and the locked configuration, nothing may happen if the door handle 52 is moved manually. In this regard, the touch switch 74, alone, may be used to unlock, unlatch and open the door assembly 22 to the open configuration and then place the door assembly in the closed configuration using the PSD unit 180 if the door assembly 22 is in the locked configuration.

In some embodiments, the door operating system 150 further includes network interface hardware 162 for communicatively coupling the door operating system 150 with a network 167. The network interface hardware 162 can be communicatively coupled to the communication path 154 and can be any device capable of transmitting and/or receiving data via the network 167. Accordingly, the network interface hardware 162 can include a communication transceiver for sending and/or receiving any wired or wireless communication. For example, the network interface hardware 162 may include an antenna, a modem, LAN port, Wi-Fi card, WiMax card, mobile communications hardware, near-field communication hardware, satellite communication hardware and/or any wired or wireless hardware for communicating with other networks and/or devices. In one embodiment, the network interface hardware 162 includes hardware configured to operate in accordance with the Bluetooth wireless communication protocol. In another embodiment, network interface hardware 162 may include a Bluetooth send/receive module for sending and receiving Bluetooth communications to/from a mobile device 168.

The door operating system 150 may communicate, through the network interface hardware 162, with the network 167 to communicatively couple the door operating system 150 with the mobile device 168. In one embodiment, the network 167 is a personal area network that utilizes Bluetooth technology to communicatively couple the door operating system 150 and the mobile device 168. In other embodiments, the network 167 may include one or more computer networks (e.g., a personal area network, a local area network, or a wide area network), cellular networks, satellite networks and/or a global positioning system and combinations thereof. Accordingly, the door operating system 150 can be communicatively coupled to the network 167 via wires, via a wide area network, via a local area network, via a personal area network, via a cellular network, via a satellite network, etc. Suitable local area networks may include wired Ethernet and/or wireless technologies such as, for example, wireless fidelity (Wi-Fi). Suitable personal area networks may include wireless technologies such as, for example, IrDA, Bluetooth, Wireless USB, Z-Wave, ZigBee, and/or other near field communication protocols. Suitable personal area networks may similarly include wired computer buses such as, for example, USB and FireWire. Suitable cellular networks include, but are not limited to, technologies such as LTE, WiMAX, UMTS, CDMA, and GSM.

In some embodiments, the mobile device 168 may be included as a user input device. The mobile device 168 may include a processor and a memory module. The processor 155 can execute logic to communicate with the door operating system 150 in order to facilitate sending instructions to the door operating system 150 from the mobile device 168. The mobile device 168 may be configured with wired and/or wireless communication functionality for communicating with the door operating system 150. In embodiments described herein, the mobile device 168 may include mobile phones, smartphones, personal digital assistants, dedicated mobile media players, mobile personal computers, laptop computers, and/or any other mobile devices capable of being communicatively coupled with the door operating system 150. It is noted, that in this embodiment, the door operating system 150 may communicate with the mobile device 168 even while the mobile device 168 is outside of a cabin of the vehicle 10. In this way, the door operating system 150 may be controlled with the mobile device 168 from outside of the vehicle 10.

The door operating system 150 may further include a drive mode sensor 172 communicatively coupled over the communication path 154 to other vehicle modules. The drive mode sensor 172 may be configured to detect a particular driving mode of the vehicle 10. For example, the drive mode sensor 172 may detect whether the vehicle 10 has been placed in a park driving mode (e.g., park) and output a driving mode signal regarding the same. In one embodiment, the drive mode sensor 172 may be communicatively coupled with a gear shifter of the vehicle 10 and may output a driving mode signal indicative of the gear in which the vehicle 10 has been placed. The door operating system 150, based on the driving mode of the vehicle 10, may execute logic to automatically operate the door operating system 150. For example, the door operating system 150 may only allow operation of the door latch assembly 40 and/or the door lock assembly 60 if the vehicle 10 is in park.

In some embodiments, the door operating system 150 may include a key fob 170 that communicates with the processor 155 to lock and unlock the door lock assembly and latch and unlatch the door latch assembly 40. The key fob 170 may be a transponder that can communicate with the processor 155 via various antennas, which may be located at various positions on the vehicle 10. The antennas may periodically send a signal in a polling fashion that causes the key fob 170 to reply with a unique security code, which is received by the processor 155 when the key fob 170 is within a predetermined range of the vehicle 10. Once the security code is received and verified by the processor 155, the processor 155 may the door operating system 150. Without the key fob 170 being present, the door operating system 150 may be unavailable.

The above-described door operating systems including door handle assemblies provide a door handle that is entirely moveable without a stationary portion and a gap between a moveable door handle and the stationary portion. The door handle assemblies include a touch switch on the door handle that can be used to lock and unlock a door lock assembly to allow for latching and unlatching of a door latch assembly. In some embodiments, the touch switch may also be used to latch and unlatch the door latch assembly and may even be used to initiate an automated door opening procedure where the door assembly is moved from a closed configuration to an open configuration and vice versa. The door handle, itself, may also be used to lock and unlock the door lock assembly and may also be used to latch and unlatch the door latch assembly. The door handle may be moveable between a latched configuration, an unlocked configuration and an unlatched configuration.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A vehicle comprising:
a body;
a vehicle door assembly coupled to the body, wherein the vehicle door assembly comprises:
a door latch assembly operable to latch and unlatch the vehicle door assembly to the body;
a door lock assembly operable to lock and unlock the door latch assembly; and
a door handle assembly operatively coupled to the door latch assembly, the door handle assembly moves between a latched configuration and an unlatched configuration;
an actuator that actuates the door lock assembly;
wherein the door handle assembly is gapless and comprises a handle body that pivots about a pivot axis between the latched configuration and the unlatched configuration, the handle body comprising a touch switch that is used to control operation of the actuator.

2. The vehicle of claim 1 further comprising:
a processor; and
a memory module communicatively coupled to the processor that stores logic that, when executed by the processor, instructs the actuator to actuate the door lock assembly based on actuation of the touch switch.

3. The vehicle of claim 2, wherein the memory module is communicatively coupled to the processor that stores logic that, when executed by the processor, instructs the actuator to actuate the door latch assembly based on actuation of the touch switch.

4. The vehicle of claim 1 further comprising a power slide door unit that moves the door assembly between an open configuration and a closed configuration.

5. The vehicle of claim 4, wherein the power slide door unit moves the door assembly from the closed configuration to the open configuration based on actuation of the touch switch.

6. The vehicle of claim 5 wherein the handle body has an internal volume, the door handle assembly further comprising a connector assembly comprising a communication line that extends from the touch switch toward the pivot axis.

7. The vehicle of claim 6, wherein the touch switch is located nearer an end of the handle body than the pivot axis.

8. The vehicle of claim 5 further comprising:
a processor; and
a memory module communicatively coupled to the processor that stores logic that, when executed by the processor, instructs either the actuator to actuate the door lock assembly when the touch switch is actuated or instructs the power slide door unit to place the door assembly in the open configuration if the door assembly is in the unlocked configuration and closed configuration when the touch switch is actuated.

9. A vehicle door assembly comprising:
a door latch assembly operable to latch and unlatch the vehicle door assembly to the body;
a door lock assembly operable to lock and unlock the door latch assembly; and
a door handle assembly operatively coupled to the door latch assembly, the door handle assembly moves between a latched configuration and an unlatched configuration; and
an actuator that actuates the door lock assembly;
wherein the door handle assembly is gapless and comprises a handle body that pivots about a pivot axis between the latched configuration and the unlatched configuration, the handle body comprising a touch switch that is used to control operation of the actuator.

10. The vehicle door assembly claim 9 further comprising a power slide door unit that moves the door assembly between an open configuration and a closed configuration.

11. The vehicle door assembly of claim 10, wherein the power slide door unit moves the door assembly from the closed configuration to the open configuration based on actuation of the touch switch.

12. The vehicle door assembly of claim 11 wherein the handle body has an internal volume, the door handle assembly further comprising a connector assembly comprising a communication line that extends from the touch switch toward the pivot axis.

13. The vehicle door assembly of claim 12, wherein the touch switch is located nearer an end of the handle body than the pivot axis.

14. The vehicle door assembly of claim 12, wherein the handle body comprises an outboard portion and an inboard portion that is coupled to the outboard portion defining the internal volume.

15. The vehicle door assembly of claim 14, wherein the communication line exits the internal volume through an opening in the inboard portion.

16. A method of operating a vehicle door assembly comprising a door handle assembly, the method comprising:
instructing a door lock assembly to actuate from an unlocked configuration to a locked configuration with an actuator using a touch switch and a processor;
instructing a door latch assembly to actuate from a latched configuration to an unlatched configuration with the actuator using the touch switch and the processor; and
instructing a power slide door unit to move the door assembly from a closed configuration to an open configuration using the touch switch and the processor;
wherein the door handle assembly is gapless and comprises a handle body that pivots about a pivot axis between the latched configuration and the unlatched configuration, the handle body comprising the touch switch.

17. The method of claim 16 further comprising, with the processor, instructing the door latch assembly to actuate from the latched configuration to the unlatched configuration if the door handle assembly is in an unlatched configuration.

18. The method of claim 16 comprising a memory module communicatively coupled to the processor that stores logic that, when executed by the processor, instructs the actuator to actuate the door lock assembly based on a signal from the touch switch.

19. The method of claim 18, wherein the memory module is communicatively coupled to the processor that stores logic that, when executed by the processor, instructs the actuator to actuate the door latch assembly based on a signal from the touch switch.

20. The method of claim 16, wherein the touch switch is located nearer an end of the handle body than the pivot axis.
